(19) United States
(12) Patent Application Publication
(10) Pub. No.: US 2009/0121542 A1
(43) Pub. Date: May 14, 2009

(54) TRACK FOR A MACHINE

(75) Inventors: Brent M. Hunold, Holly Springs, NC (US); Haim Bear, Apex, NC (US); Sage F. Smith, Apex, NC (US); Christopher E. Daniels, Fuquay-Varina, NC (US); Christopher J. Neiger, Apex, NC (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 11/938,869

(22) Filed: Nov. 13, 2007

(51) Int. Cl. B62D 55/24

(52) U.S. Cl. 305/165; 305/185; 180/9.21

(57) ABSTRACT

A track for a machine. The track may include a plurality of cavities penetrating a sidewall of the track. The track may include an inner surface, an outer surface, a middle region and two sidewalls. The plurality of cavities may penetrate the sidewall and extend through the middle region of the track to the opposite sidewall.

### TECHNICAL FIELD

The present disclosure relates generally to a track for a machine, and more specifically to a plurality of cavities penetrating the sidewall of the track.

### BACKGROUND

Because machines often operate in harsh environments and are continuously cycling through no load and relatively heavy loads, machines need to be durable and able to transport the loads effectively. It is generally accepted that track machines are able to effectively traverse harsh environments and efficiently transfer torque of the drive mechanism with minimal power loss. However, track machines generally provide a less than smooth ride to a machine operator.

In order to provide a smoother ride and to extend the life of the machine and machine undercarriage, track machine manufactures have made machine undercarriages using elastomeric tracks and track components and have added suspensions to the machine undercarriage. While elastomeric tracks have improved the ride of the track machine, they are still often comprised of solid elastomeric products to provide sufficient durability, but are still generally too stiff to provide a smooth ride and too stiff to affect wear of the machine undercarriage.

The present disclosure is directed at overcoming one or more of the problems set forth above.

### SUMMARY OF THE DISCLOSURE

It is to be understood that both the foregoing general description and the following detailed description are exemplary and explanatory only and are not restrictive of the disclosure as claimed.

One aspect of the present disclosure is directed toward track for a machine. The track may comprise at least one track section composed of an elastomeric material, the track section having a sidewall. The sidewall may have a plurality of cavities penetrating the sidewall.

Another aspect of the present disclosure is directed toward an undercarriage for a machine. The undercarriage may have an elastomeric track having a sidewall and plurality of cavities penetrating the sidewall. A drive member may be configured to engage the track.

Another aspect of the present disclosure is directed to a tracked machine. The track may be composed of an elastomeric material and have a sidewall and a plurality of cavities that penetrate the sidewall.

### BRIEF DESCRIPTION OF THE DRAWINGS

The accompanying drawings, which are incorporated in and constitute a part of this specification, illustrate several exemplary embodiments of the disclosure and, together with the description, serve to explain the principles of the disclosure. In the drawings,

FIG. 1 is a view of a machine having an undercarriage with a track having a plurality of cavities penetrating a sidewall of the track, according to one embodiment of the present disclosure;

FIG. 2 is a view of the undercarriage of FIG. 1 showing the track having a plurality of cavities penetrating the sidewall of the track, according to one embodiment of the present disclosure; and

FIG. 3 is a collection of diagrammatic representations of various-shaped cavities for the track, according to embodiments of the present disclosure.

### DETAILED DESCRIPTION

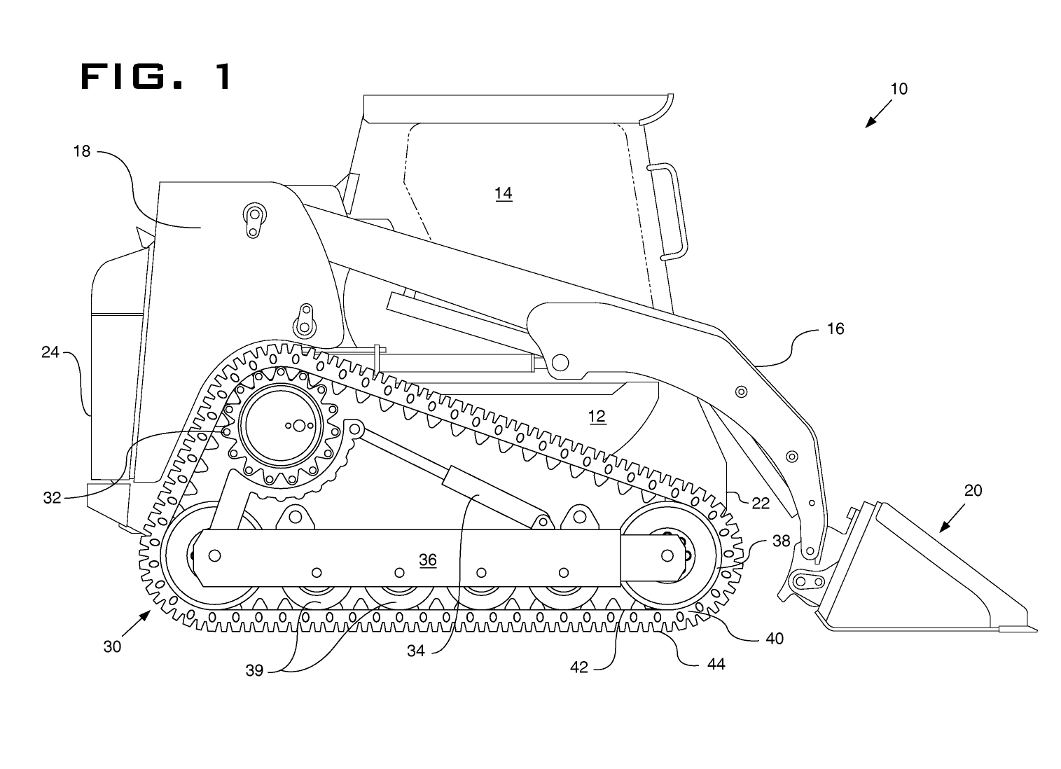

A machine 10 in accordance with one embodiment of the present disclosure is illustrated in FIG. 1. Although the machine 10 is shown as a multi-terrain skid steer loader configured to engage the ground, it should be recognized that the machine 10 could be any belt or track driven machine, or any machine having front and rear wheels capable of having a belt entrained around those front and rear wheels. Those skilled in the art will appreciate that the present disclosure also contemplates various size of tracks or belts for use in a variety of applications on a variety of machines 10. It should also be appreciated that the track 40 may be an endless track or a track 40 comprised of a plurality of track sections.

As shown, the machine 10 includes a body portion 12, an operator compartment 14, and a lift arm assembly 16. The lift arm assembly 16 is pivotally mounted to laterally spaced side members, or uprights 18, at the rear end 24 of the body portion 12 and pivotally carries a bucket or other implement 20 at the front end 22 of the body portion 12. An undercarriage 30 may be attached to the body portion 12. The undercarriage 30 may include drive sprocket 32, track tensioner 34, undercarriage suspension (not shown), undercarriage frame 36, idler wheels 38, bogey wheels 39, and track 40. The machine 10 may also include an engine (not shown) that powers a drive system (not shown) that may be operatively connected to and drive the track 40 via the drive sprocket 32.

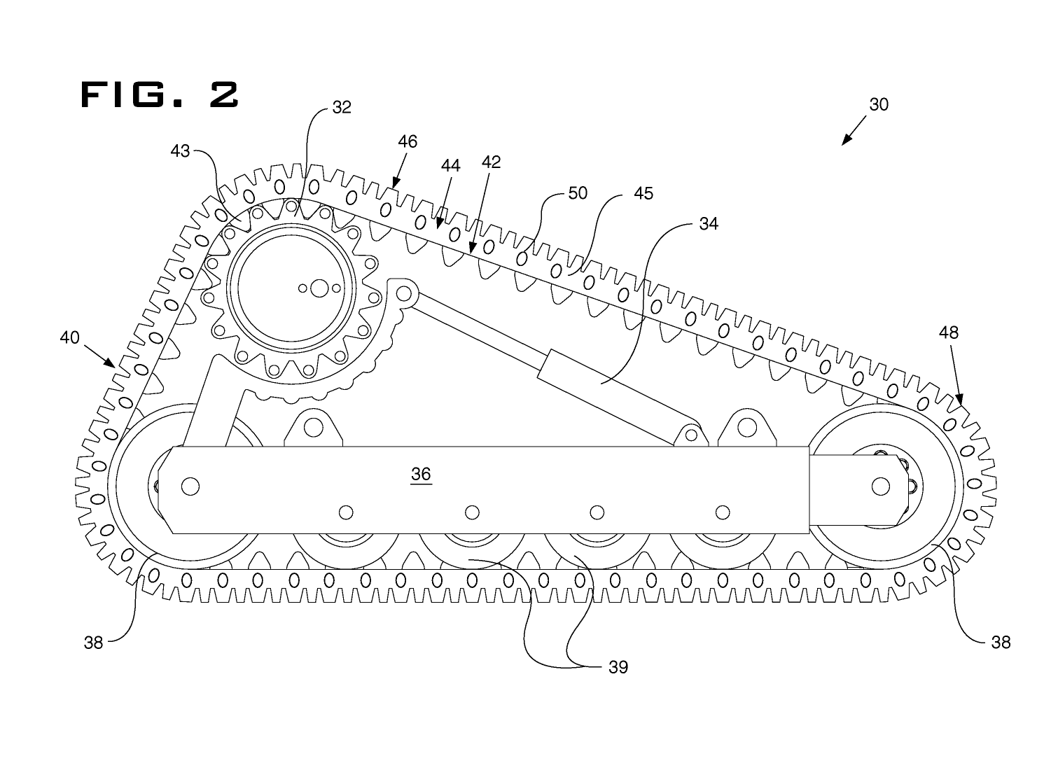

FIG. 2 is a view of the undercarriage 30 of FIG. 1 showing the track 40 having a plurality of cavities 50 penetrating the sidewall 45 of the track 40, according to one embodiment of the present disclosure. The track 40 may include an internal surface 42, a middle region 44, and an external surface 46 and may be composed of an elastomeric material. Although the track 40 may be made from various elastomeric materials, the track 40 may generally be made molded from rubber of a suitable track formulation known in the art. This formulation may be from a natural or synthetic rubber or a natural/synthetic rubber blend. Alternatively, fully synthetic elastomers, such as polyurethanes, could also be used. It is also contemplated that in various track configurations, metal may be molded into the track 40 for additional support. For example, the tracks 40 may be steel belted or may have a plurality of flat metal bars (not shown) arranged throughout the tread 40 and running a portion of the width of the track 40 for support. Alternatively, or in addition to, the tracks 40 may have a cross-hatched sheet of fabric, such as nylon, Kevlar, and the like and/or a layer of cords made from materials such as polyester and the like that are arranged within the track 40. These sheets and layers may generally be positioned along the internal surface of the track 40 and provide for additional support of the track 40.

The internal surface 42 of the track 40 may engage the drive sprocket 32, the idler wheels 38 and the bogey wheels 39. Although the internal surface 42 of the track 40 is shown having teeth 43 configured to engage the drive sprocket 32, the internal surface 42 may also be configured in one of a number of ways to engage the drive sprocket 32, such as having recesses, or openings, and the like, to be driven by the drive sprocket 32. The external surface 46 may generally include a tread 48.

The middle region 44 of the track 40 may define a plurality of cavities 50 penetrating the sidewall 45 of the track 40 to affect a deflection rate of the track 40. The cavities 50 may be distributed in a pattern and may be evenly spaced throughout the middle region 44 as shown in FIG. 2. It is also contemplated that the cavities 50 may be grouped to form a cluster of cavities 50 and may occur in one or more radial bands of cavities 50. Multiple radial bands of cavities 50 may or may not overlap, depending upon the desired properties of the track 40 in a particular set of applications. Furthermore, the band, or bands, of cavities 50 may also have different configurations and orientations and may only extend a portion of the way through the width of the track 40. Alternatively, the cavities 50 may extend from sidewall 45 to a sidewall (not shown) on the opposite side of the track 40.

Although the track 40 is shown as an endless track 40, the track 40 may be comprised of a plurality of track sections (not shown). Each track section may be connected together to form the track 40. Each track section may have a plurality of cavities 50 that penetrate into the sidewall 45 of each track section.

Those skilled in the art may appreciate that the cavities 50 may be structured to compress at particular loads of the machine 10. The cavities 50 within the track 40 lessen the stiffness of the track 40 in order to provide deflection and a relatively smooth ride for the operator, the load and the machine 10. Altering the number and structure of the cavities 50 may permit the cavities 50 to deflect by bending, rather than by either pure compression or stretching, thereby limiting the material strain while permitting substantial deflections. This may be accomplished by angling the cavities 50 in a plurality of radial bands at positive and negative angles with respect to one another. Adjusting the shape and orientation of the cavities 50 may impart slightly different physical characteristics to the track 40. However, with any arrangement of cavities 50, the track 40 should include sufficient material in order to carry the loads to which the machine 10 is subjected. Thus, a determination of a ratio of the material volume of the track 40 to the combined void volume of the cavities 50, or the total percentage of void volume, may be necessary to find a desired stiffness and strain and durability of the track 40. For example, in one embodiment of the track 40, the material volume of the track 40 may be about ten times the void volume of the cavities 50, or a total void volume of the cavities 50 that may represent approximately ten percent of the total volume of the track 40. However, this volume may vary significantly based upon the configuration of the cavities 50, the radial middle region 44, the internal surface 42, teeth 43, the external surface 46, the width of the track 40, the chosen materials of the track 40, a desired ride, and the like. For example, the total void volume of the track 40 may be anywhere from about five percent up to twenty percent of the total volume of the track. However, this percentage may significantly increase is considering the total material volume of only the middle region 44 as compared to the void volume of the cavities 50.

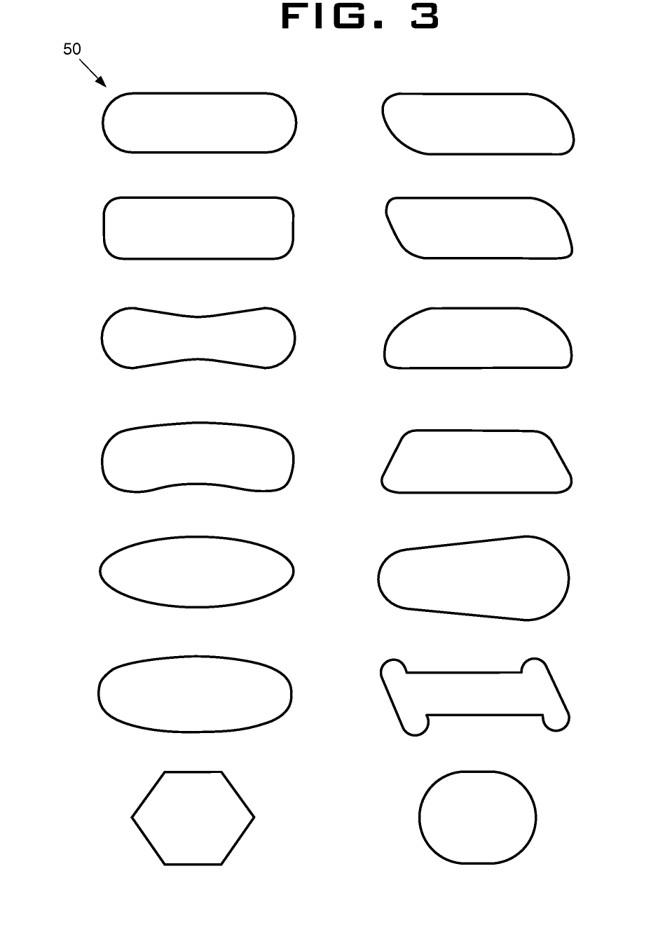

FIG. 3 is a collection of diagrammatic representations of various-shaped cavities for the track, according to embodiments of the present disclosure. Although the cavities 50 are shown having an oval shape extending from the sidewall 45 of the track 40 through the width of the track 40, the present disclosure contemplates use of cavities 50 of a variety of shapes, such as those shown in FIG. 3, and the like. The shapes may be symmetrical, but may also be skewed. Further, the present disclosure contemplates a track 40 including non-uniform cavities 50. Each cavity 50 may also include a taper (not shown). The taper may eases the removal of a molding core from the elastomeric material to form the cavities 415 during manufacturing. A taper can impart a different spring rate to the track 40, and can be used to tailor the ground pressure distribution under the track 40, i.e. cause the middle of the track 40 to carry more load. It is also contemplated that the taper may apply to any one of a number of cavity geometries. Those skilled in the art may appreciate that various configurations of cavities 50, such as the size, shape, number, and orientation of the cavities 50, in addition to having multiple bands of cavities 50 may provide a desired stiffness, torque cancellation, and durability of the track 40.

The present disclosure contemplates that the cavity 50 may include a barrier (not shown) separating the cavities 50 from the space surrounding the track 40. The barriers (not shown) may prevent debris from entering the cavities 50 and affecting the performance of the track 40. The present disclosure contemplates the barriers (not shown) being comprised of various materials, including, but not limited to a thin screen or rubber layer over the cavity 50, or possibly by filling the cavity 50 with an elastomeric foam. Those skilled in the art will appreciate that the material for the barriers (not shown) can be selected to alter the deflection rate of the track 40, or to not affect the performance of the track 40.

Alternatively, the deflection rate of the track 40 may be altered through the use of a sleeve (not shown) or adjustable insert (not shown) that may conform to fit within, at least, a portion of the cavities 50. The sleeves and adjustable inserts may only contact a portion of the inner surface of the cavities 50 or may extend all or part of the way through the width of the track 40. Use of a sleeve or adjustable insert may become increasingly important over the life of the track as the deflection rate may change over time.

### INDUSTRIAL APPLICABILITY

Operation of the present disclosure will be discussed for a machine 10 having an undercarriage 30 with a track 40 having a plurality of cavities 50 penetrating a sidewall of the track 40. Those skilled in the art should appreciate that the operation of the present disclosure may be similar for various machines 10 having tracks 40 with cavities 50.

During normal operation of the machine 10, the engine (not shown) powers the drive system (not shown) that may be operatively connected to and drive the undercarriage 30 via the drive sprocket 32. The drive sprocket 32 engages the internal surface 42 of the track 40 and causes the track 40 to move about the drive sprocket 32, the idler wheels 38, and bogey wheels 39. As the track 40 moves between the ground and the idler wheels 38 and bogey wheels 39, the track 40 will be subjected to a predictable range of radial loads. To absorb the radial loads differently than in a convention track, cavities 50 may be added to a middle region 44 of the track 40, extending from the sidewall 45 through at least a portion of the width of the track 40 to absorb the radial loads by deforming the material about the cavities 50 rather than transmitting effects of the radial load to the undercarriage 30, machine 10 or operator. The cavities 50 may be tailored with idea of satisfactorily accommodating the predictable range of radial loads to provide a suspension, or secondary suspension, to the machine 10 and undercarriage 30. Accordingly, the track 40 may have stiffness less than that of a solid track to provide the operator with a smoother ride and decreasing wear to the undercarriage 30. Increasing ground contact and traction of the track against the ground is also possible depending on the configuration of the cavities 50.

It should be understood that the above description is intended for illustrative purposes only, and is not intended to limit the scope of the present disclosure in any way. Thus, those skilled in the art will appreciate that other aspects, objects, and advantages of the disclosure can be obtained from a study of the drawings, the disclosure and the appended claims.

What is claimed is:

1. A track for a machine, comprising:
at least one track section composed of an elastomeric material, the track section having a sidewall; and
a plurality of cavities penetrating the sidewall.

2. The track of claim 1, wherein the track is a ground engaging track.

3. The track of claim 2, wherein an inner surface of the track engages a drive member of the machine and an outer surface of the track engages the ground.

4. The track of claim 2, wherein the plurality of cavities are configured to provide suspension to the machine.

5. The track of claim 2, wherein the plurality of cavities extend a width of the at least one track section.

6. The track of claim 2, wherein the plurality of cavities extend from the sidewall to an opposite sidewall.

7. The track of claim 2, wherein the track is an endless track.

8. The track of claim 2, wherein the outer surface includes a tread.

9. The track of claim 1, wherein the track has a material volume and the cavities have a combined void volume, the material volume being about ten times greater than the combined void volume.

10. An undercarriage for a machine, comprising:
an elastomeric track having a sidewall and plurality of cavities penetrating the sidewall; and
a drive member engaging the track.

11. The undercarriage of claim 10, wherein the cavities are configured to provide suspension to the undercarriage.

12. The undercarriage of claim 11, wherein the plurality of cavities extend from the sidewall to an opposite sidewall.

13. The undercarriage of claim 11, wherein the track is an endless track.

14. The undercarriage of claim 11, further comprising:
at least one idler wheel; and
at least one bogey wheel, the track being driven about the drive member, the at least one idler wheel and the at least one bogey by the drive member.

15. A tracked machine, comprising:
a track composed of an elastomeric material, the track having a sidewall; and
a plurality of cavities penetrating the sidewall.

16. The tracked machine of claim 15, wherein the track is a ground engaging track.

17. The tracked machine of claim 16, wherein the plurality of cavities extend from the sidewall to an opposite sidewall.

18. The tracked machine of claim 16, wherein the track includes a plurality of track sections, each track section having a plurality of cavities.

19. The tracked machine of claim 16, wherein the track is an endless track.
